(19) United States
(12) Patent Application Publication
(10) Pub. No.: US 2007/0001123 A1
(43) Pub. Date: Jan. 4, 2007

(54) A METHOD AND APPARATUS FOR DETECTION OF RADIOACTIVE MATERIALS

(76) Inventors: Hugh Robert Andrews, Pembroke (CA); Jimmy Chun-leung Chow, Deep River (CA); Edward Thomas Homfray Clifford, Deep River (CA); Hui Gao, Deep River (CA); Harry Hon Kin Ing, Deep River (CA); Lianne Dora Ing, Cobden (CA); Vernon Theodore Koslowsky, Deep River (CA); Liqian Li, Deep River (CA); Darren Adam Locklin, Petawawa (CA); Donald Clifford Tennant, Deep River (CA)

Correspondence Address: IAN FINCHAM, SUITE 606, 225 METCALFE STREET, OTTAWA, ON, K2P 1P9, CA

(21) Appl. No.: 11/160,729

(22) Filed: Jul. 6, 2005

(30) Foreign Application Priority Data
Oct. 18, 2004 (US) 60/618,990
May 5, 2005 (US) 60/594,778

(51) Int. Cl. G01T 1/00

(52) U.S. Cl. 250/394

(57) ABSTRACT

In the present invention there is a provided an array of radiation detectors comprising at least one detector capable of detecting both low and high energy gamma radiation and adapted to provide spectrometric identification of the gamma source; at least one detector capable of detecting and providing spectrometric identification of fast neutrons and low resolution gamma spectra; at least one detector adapted to detect thermal neutrons; and, at least one plastic scintillator to give enhanced gamma ray sensitivity.

### FIELD OF THE INVENTION

The present invention relates to radiation detectors and more specifically to a method and apparatus for detection of radiation-emitting materials or devices in parcels, on people, in vehicles, and shipping containers.

### BACKGROUND OF THE INVENTION

Detection of radioactive materials in transit is commonly achieved through the use of portal monitor units. These portal monitors are positioned at control points and are generally based on large plastic scintillator detectors for gamma-ray intensity and crude gamma-ray energy determination and ³He counters for detection of thermal neutrons. These systems offer detection sensitivity but little spectral information thus not permitting rapid and accurate identification of SNMs (Special Nuclear Materials) and, as a result, impede the efficient flow of goods and people due to false alarms. Using thermal neutrons for detection is not source-specific, as the materials of interest actually emit characteristic fast neutron distributions, which are then intentionally thermalized by a hydrogenous material that surrounds the ³He tube.

The direct detection of the fast neutrons themselves offers additional detection sensitivity as well as valuable information about the nature of the neutron-emitting source.

In the application of radiation portal monitors, the field-of-view of the detectors generally includes a target to be screened (in front of the face of a detector), as well as the ground or floor beneath and in the direct vicinity of the target. The ground contributes a substantial amount of “background” gamma radiation in the low-energy (less than˜1 MeV) region of the energy spectrum from a variety of sources, including natural radioactivity in the ground and radiation induced by cosmic ray interactions. This background radiation competes with any low-energy gamma radiation signals coming from a radioactive source in the target, thereby adversely affecting the signal-to-noise ratio in the low-energy portion of the spectrum and hence, reducing the sensitivity of the detectors to a radioactive source in the target.

There is presently a need for improved radiation detectors that overcome the difficulties outlined hereinabove. For example, improved detection and identification of a radioactive source.

### SUMMARY OF THE INVENTION

In one embodiment of the present invention there is provide an array of radiation detectors comprising:

at least one detector capable of detecting both low and high energy gamma radiation and adapted to provide spectrometric identification of the gamma source;

at least one detector capable of detecting and providing spectrometric identification of fast neutrons and low resolution gamma spectra;

at least one detector adapted to detect thermal neutrons; and,

at least one plastic scintillator to give enhanced gamma ray sensitivity.

Preferably, the detector of i) is selected from at least one low energy photon detector sensitive to low energy gamma radiation for suppressing competing background from high energy radiation or included with at least one Nal (Tl) detector, further includes additional high resolution detectors selected to enhance radioactive isotope identification, the array is incorporated in a panel, the panel having processing means, the array further includes means for wireless data transmission, means for data fusion techniques, and i) comprises sodium iodide activated by thallium (Nal(Tl)) detectors.

It is further desirable the low energy photon detector comprises Nal (Tl) (activated by thallium) scintillator backed by Csl (Na) scintillator.

In the above embodiment it is desirable iii) comprises liquid scintillation fast neutron detectors with a volume of the order of 5 inch diameter×24 inch long, the spatial arrangement of i) to iv) is designed to distribute sensitivity uniformly over the detecting surface, and the array is adapted to be controlled from a remote location.

It is further preferred that each panel includes processing means for calibrating and correcting raw data from each of (i) to (iv) to yield an output, and the panel comprises part of a system having a plurality of panels.

It is even further desirable the plurality of panels are configured to form a portal monitor for one of pedestrians, parcels, vehicles, containers or rail cargo, the array further includes a power source and an indicator device, and the portal monitor unit is remotely controlled.

In another embodiment of the present invention there is provided a portal monitor for detecting radiation from a target, comprising:

at least one panel, each the panel including an array having:

at least one detector capable of detecting both low and high energy gamma radiation;

at least one liquid scintillator-based detector capable of neutron/gamma pulse-shape discrimination to provide spectrometric identification of fast neutrons and low resolution gamma spectra;

at least one detector for thermal neutrons,

at least one plastic scintillator to give enhanced gamma ray sensitivity; and,

a shielding baffle mounted on each the panel for reducing background radiation interference emanating from at least below the target.

Desirably, the shielding baffle is of a Venetian-blind configuration, and the background radiation being shielded is low energy gamma, alpha or beta.

In another embodiment a method for real-time radiation detection, comprising:

providing a detector array having a face and including (i) at least one detector capable of detecting both low and high energy gamma radiation, (ii) at least one liquid scintillator-based detector capable of neutron/gamma pulse-shape discrimination to provide spectrometric identification of fast neutrons and low resolution gamma spectra, (iii) at least one detector for thermal neutrons, and (iv) at least one plastic scintillator to give enhanced gamma ray sensitivity, with the face directed at a target;

positioning at least one baffle substantially horizontally against the face of the detector array, the face having a lowest edge and at least one baffle being at the lowest edge for the baffle to protrude outwardly and transversely across the width the face;

shielding each of (i) to (iv) with at least one baffle to produce a raw data;

processing the raw data at each detector of the detector array to calibrate and correct the raw data; and,

yielding an output from the processed data sufficient for the desired identification.

Having now generally described the present invention in the preferred embodiments reference will now be made to the accompanying drawings.

### BRIEF DESCRIPTION OF THE DRAWINGS

FIG. 1 illustrates the detection array of one embodiment of the present invention;

FIG. 2 illustrates spectra for the analysis and detection of a target (¹³³Ba(21 μCi) behind various shielding;

FIG. 3 illustrates signal extraction produced from the detection array of the present invention as a vehicle passes through the field of view of the array;

FIG. 4 illustrates detailed source-specific information provided on a real-time basis; and,

FIG. 5 illustrates shielding baffles to be positioned on the detection array panel of a monitor.

### DETAILED DESCRIPTION OF THE INVENTION

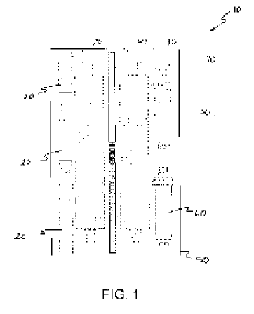

One detection array 10 of the present invention is shown in FIG. 1. The detection array 10 includes an adaptive array of related spectrometric neutron and gamma ray detectors 20, 30 as well as ³He thermal-neutron counters 40 chosen to maximize sensitivity and minimize false positives to meet the ANSI N42.38-WD-F1 a standard.

The spectrometric sensors 20, 30 provide gamma and neutron source identification, thus discriminating among natural background and materials, special nuclear materials and industrial or medical isotopic radiation. The detection array 10 can constitute a modular unit that can be deployed e.g. one to three high on one or both sides of an inspection lane to form panels that can be deployed one to three high on one or both sides of an inspection lane (not shown). The panels 50 can also be deployed as a plurality of panels 50 side by side according to a desired configuration. The appropriate configuration will be defined by the application including pedestrian, parcel, passenger vehicle, truck, container or rail cargo inspection. Further, the panel frame can be constructed of any conventional type material.

The detection array 10 is comprised of a combination of a number of detector types including:

1. large Nal(Tl) (sodium iodide activated by thallium) detectors for gamma detection and spectrometry of gamma rays from below 30 keV to about 10 MeV energy;

2. specially-configured Low Energy Photon Detectors (LEPDs), sensitive to lower energy gamma rays with suppression of the competing background from ambient high energy radiation;

3. liquid-scintillator-based detectors with neutron/gamma pulse-shape discrimination, providing clear spectrometric identification of fast neutrons, as well as low-resolution gamma spectra;

4. ³He detectors for ambient thermal neutrons; and,

5. plastic scintillators e.g. as large slabs with one or more photomultiplier tubes to give cost-effective, high-sensitivity gamma ray detection with modest energy resolution.

Optionally, additional higher resolution detectors (not shown) such as Ge, LaBr₃, LaCl₃, or CZT (Cadmium Zinc Telluride) can be added to enhance isotope identification if deemed necessary.

The detection array 10 can employ selected modular spectrometric detectors for fast neutrons and gamma rays in addition to conventional thermal neutron detectors. For example, these could be chosen from, but are not limited to the following:

1. selected large volume (e.g. 4″×4″×16″ Nal(Tl) detectors, with wide energy range from <30 keV up to ˜10 MeV to allow detection of high energy gamma radiation from fission and (alpha, n) neutron sources, as well as lower energy radiation typical of medical and industrial isotopes, SNMs and natural background and materials;

2. selected low-energy photon detectors (LEPD) comprised of a large diameter (5 inches typical) thin Nal(Tl)scintillator backed by a thick Csl(Na) (Cesium iodide) scintillator to veto Compton-scattering events arising in the Nal(Tl) layer. The Csl(Na) detector also supplies a good quality higher energy gamma spectrum. Pulse-shape analysis is used to separate the two types of events;

3. large volume liquid-scintillation fast-neutron detectors (for example 5 inch diameter×24 inch long) with n/gamma pulse-shape discrimination. This detector provides information about neutron energy, which can differentiate between fission sources and various (alpha, n) industrial sources. The latter, because of their very high alpha activity, would be particularly dangerous elements in a radiological dispersion device (RDD) or “dirty bomb”. This detector also provides low resolution gamma spectra comparable to that from many present generation systems based on plastic scintillators;

4. large volume plastic scintillator panels to provide gamma-detection sensitivity as well as spatial and temporal localization data; and,

5. conventional ³He thermal-neutron counters to provide corroboration of the presence of neutrons by a quite independent detection modality.

Examples of conventional types of detectors and their uses can be found in “Radiation Detection and Measurement” third ed. 2000, Glenn F. Knoll, John Wiley & Sons Inc., incorporated in full herein. A conventional La C1₃ detector is of the type disclosed in E V D van Loef, W. Mengesha, J D Valentine, P Dorenbos and C W E van Eijk, IEEE Transactions on Nuclear Science, Vol. 50, No. 1, February 2003, also incorporated in full herein.

The detailed and independent information available from this sensor array 10, including time evolution of count rates and relative intensities, allows scope for data fusion techniques to define the nature and, in many cases, the general location of the source of radiation. For example, plutonium-based materials are characterized by a fission neutron spectrum, the presence of high energy gamma rays and, depending on shielding, lower energy gamma rays and X-rays characteristic of actinides. Alpha-n sources they have higher energy neutrons and, in the case of the most common Be-based sources, also exhibit characteristic high energy gammas. Industrial and medical isotopes have discrete gamma lines that would be identified by energy peak analysis, and complex sources, such as spent reactor fuel, would be indicated by gamma activity whose spectral intensity would not be explicable by the observed peak structure. These detailed interpretations are made possible by the presence of excellent quality spectrometric neutron and gamma ray data, not obtainable from the conventional plastic-scintillator-based systems.

Ability to detect shielded Special Nuclear Material (SNM)

The detection array 10 detects SNM through the functioning of individual detectors. It is a passive detection system and its technologies could be easily incorporated into a neutron or gamma interrogation system. It can detect spontaneous radiation emitted by the SNM: characteristic gamma rays from radioactive decay of primary isotopes or in-growing progeny; neutrons from spontaneous fission or alpha-induced reactions on light elements; high-energy prompt gammas accompanying fission; and beta-delayed high-energy gamma rays from fission products.

Accordingly, a processing means 70 is also provided for individual activation and operation of each detector which enables the processing of the raw data from each detector to yield calibrated, corrected signal and background data sent to a main portal computer via, for example, an Ethernet™ cable and local area network. The array is “plug and play” in that the system can simply be plugged in and operation can begin The processing means 70 can include, for each detector in the system, a “smart detector” (not shown) that is equipped with its own electronics and single board computer for the purpose of conducting the basic data acquisition, sensor health checks, and computation required to produce energy-calibrated, background-corrected radiation data. This can include accumulating relevant background data for the detector, energy-calibrating the detector using either natural background radiation or a calibration source embedded in the detector, and correcting the data for any non-linearities in the detector response.

The data from the “smart detectors” is passed from each detector to a panel computer, which aggregates data from common detector types within a panel and passes the data to the portal computer. The portal computer performs all of the data analysis and generates radiation alarms as required. Data analysis at the portal computer level includes pattern recognition in the plastic detectors to detect gamma anomalies, region of interest analysis of the relevant sodium iodide data as defined by the plastic detectors, isotope identification using both template fitting and peak identification techniques on the spectroscopic data, and fusion of data from the gamma and neutron sensors to determine the nature of the threat, its approximate source strength and shielding configuration, and approximate location of the source in the cargo.

Information from the portal computer is then passed to a supervisory computer which logs all the data, controls the configuration of all the portal parameters, and provides the user interfaces that allow the user to interact with the portal system.

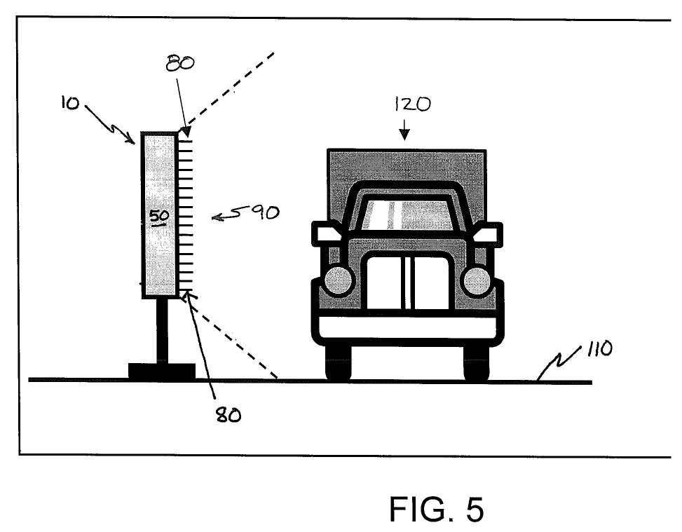

The processing means 70 in FIG. 1 is an electronic stack architecture in direct communication with the detectors 20, 30, 40, etc. of the detector array 10, a power source (not shown) and algorithms for spectroscopic calibration and resampling to facilitate the extraction of weak/complex signals from the background. The presence of the vehicle itself before the panel 40 (see FIG. 5) can change the background level by up to 40%. Thus, the algorithms in the portal or central computer of the present invention can dynamically track and adjust the signals received from each detector to recognize shape changes, provide accurate isotope identification and information on the pulse-shape discrimination and pile-up rejection, region-of-interest analysis, nuclear physics based statistical techniques, two-dimensional analysis, fusion of data from different types of sensors to obtain better information of the identity and location of sources and the shielding of same.

The array 10 or detector suite is designed to exploit these following indicators of SNM:

1. Some Pu isotopes are characterized by spontaneous fission, producing fast neutrons and high-energy gamma rays. They also generate a number of low-energy gamma rays that may be detectable depending on the effectiveness of shielding around the source. The liquid scintillator array in FIG. 1 efficiently detects and identifies the fast neutrons (˜50% interaction for impinging neutrons). The ³He tubes in proximity to the scintillator bodies pick up neutrons thermalized in the scintillator and other moderators in their vicinities. It is important to note that thermal neutrons detected at a distance from a source generally arise from the thermalization of fast neutrons in the vicinity of the detector and not from the source itself. Hence, it is advantageous, in efficiency and information garnered, to detect the fast neutrons spectrometrically as well as some fraction of the thermal neutrons generated locally. The energy signals from the neutron interactions enable differentiation between fission and (alpha, n) sources, since the latter have a much harder spectrum than the former. Preferably, the gamma detectors have an extended energy range (up to 10 MeV) to capitalize on the fission-associated, high-energy gamma rays discussed above.

2. Pu isotopes emit a wide range of gamma rays from ˜40 keV up to ˜400 keV. All of these are detectable by the Nal detectors but effective detection of the lower energy quanta is facilitated by the LEPD design, which reduces the high-energy gamma background in that spectral region by a factor of ˜5 over a simple thin Nal detector.

3. The detection of ²³⁵U is achieved through its gamma emission, through that of its progeny, and impurities such as ²³²U arising in the enrichment process. ²³⁵U gammas of interest are at 185.7 keV and 143 keV. The former suffers interference from natural lines from ²²⁶Ra so that a high resolution detector would be needed to separate them. The 143 keV gamma ray is easily detected by the Nal detectors and the LEPD; the LEPD, however, is designed to minimize the background in this region so that it will provide the most efficacious detector. The 2614 keV line arising from the ²³²U contaminant arises from ²⁰⁸Tl, which is also part of the ²³²Th natural decay chain. Hence, careful treatment of background is needed to use this option. Nuclear weapons often contain natural or depleted uranium and thus detecting ²³⁸U through the characteristic 1001 keV gamma ray in its decay chain is important.

The individual detectors identified represent an “optimized compromise” among efficiency, resolution, and cost to achieve performance substantially superior to current systems based on ³He counters and plastic scintillators.

The modularity of the detection array 10, the resolution and multiplicity of individual detectors, and the shielding design as described herein offer significant advantages over existing portal systems. For example, improved detection sensitivity, through the use of both fast-neutron detectors and thermal-neutron detectors can be obtained. The discrimination between fission sources and (alpha, n) industrial sources through the use of spectrometric fast neutron detectors is also possible along with detection probabilities that can meet or exceed the ANSI N42.38-WD-F1 a standards. The present invention also provides for outstanding NORM (Naturally Occurring Radioactive Materials) discrimination properties and isotope identification through the use of spectrometric gamma detectors. It has been found that false alarms are minimized through simultaneous analysis of multiple independent detectors. Further, improved information extraction from sensor fusion of data from independent detectors and detector types can be obtained.

It has been found that source location information through the time distribution and relative intensities of signals in the elements of the detection array as the source passes through the portal can be determined. Is an enhanced system reliability is achieved from array modularity, where failure of a single detector has only a modest impact on the overall system effectiveness. The term system as used herein includes one or more panels, processing means and any communication network used for the detection of radiation The system is also easily maintained through simple array, module or element replacement. Further, it has been found that there is minimal sensitivity to background depression caused by vehicle shadowing through the entrance-face baffle configuration that limits detector vertical field of view. Thus detection of low-energy degraded natural radiation from the ground in front of the system is also minimized.

The radiation-detection array 10 preferably is augmented by ancillary detectors to sense the occupancy of the portal, to determine the entrance and exit times and target speed, as well as up to three cameras to image the approach and exit of the target, the side of the target, and optionally, the side of the target at the point of radiation alarm.

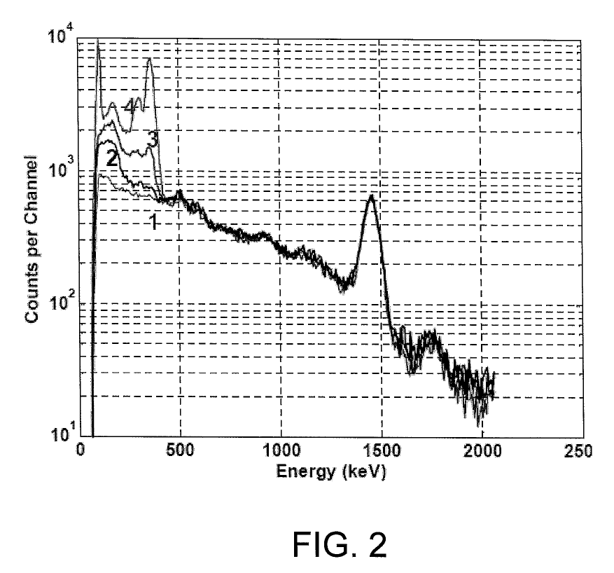

Turning to FIG. 2, the output yielded by the processing means 70 is shown byway of example as ¹³³Ba (21 μCi) being detected behind various shielding types, including where there is no shielding provided. In the figure it is shown that the background (1) is differentiated from a 6.3 cm steel shielded sample (2), a 3.1 cm steel shielded sample (3) and also an unshielded sample (4).

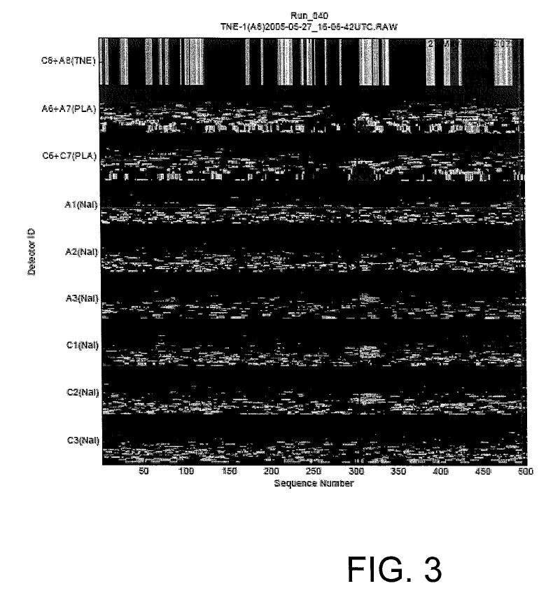

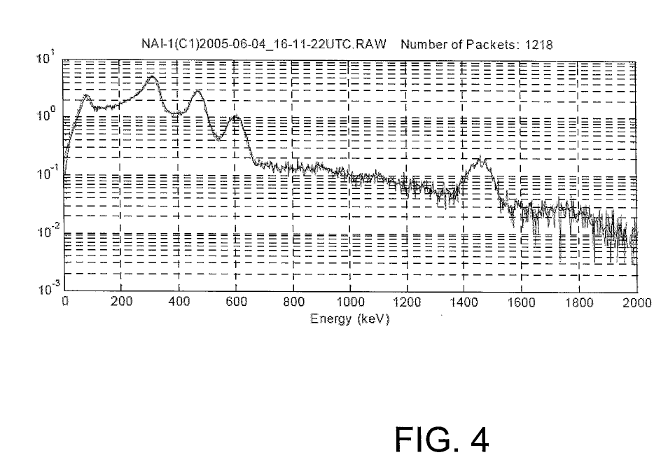

FIG. 3 shows the signal-to-noise output received from the array 10 and compiled by the program during real-time operation. This is used for the detection and characterization of spectral and temporal anomalies. In FIG. 4 the detection output shows real-time output yields identifying readily quantifiable results from the analysis. FIG. 4 shows an example Nal spectrum taken from the time-window anomaly in FIG. 3. The characteristic energies and intensities clearly identify an industrial isotope ¹⁹²Ir as the source of the radiation.

Referring now to FIG. 5, the present invention preferably further includes one or more strips or baffles 80 of lead sheet to significantly suppress the interaction of the background gamma (or alpha or beta) radiation with the detector array 10. Other suitable (gamma) radiation shielding material (e.g. tungsten or gold or any other suitable material)) are placed approximately horizontally across the face 90 of the detector array 10, with one edge 100 of the lead strips or baffles 80 being placed against (or spaced from) the face 90 of the detector array 10, creating a shielding baffle 80 configuration. The dotted lines indicate the field of view without the use of the baffles indicating that the baffled detectors are exposed to significant ground level background noise.

The preferred configuration is similar to an open “Venetian blind” and is shown in FIG. 5. However, other configurations can be used depending on the application of the detection array 10. The positioning of the inner edge 100 of the lead strips 80 can be spaced off or away from the face 90 of the detector array 10 such that the shielding effect is not significantly reduced. The vertical spacing between strips 80, the number and thickness of the strips 80, the depth of the strips 80, and the angle of the strips 80 relative to the face 90 of the detector array 10 are selected in order to optimize the balance between minimizing the signal from background radiation and maximizing the exposure of the detectors to the target for greatest detection efficiency. The shielding baffles 80 effectively reduce the detector's field-of-view exposure to the ground (or floor) 110 beneath and in the direct vicinity of the target 1 20 being investigated for a positive detection, thereby drastically reducing the strength of the background radiation signal.

Empirical studies in this context show a three-fold reduction in the background radiation signal in the low-energy portion of the spectrum for a sodium-iodide crystal gamma detector, which represents a significant increase in the detection sensitivity of the detector in the low-energy region.

The Venetian-blind configuration has practical advantages because a detector array 10 of any significant height would need a deep shielding baffle that would project out from the front face 90 of the array 10. The baffle 80 can also force the target to be a specified “standoff” distance from the detector to allow space for the baffle 80. Since the intensity of radiation decreases with “distance”, the separation of the target from the detector face would have adverse impact on the ability of the detector to detect a radioactive source in the target if the separation becomes too great.

The angle or “tilt” of the shielding baffles can be adjustable to optimize the signal-to-noise improvement. For example, if the target is above the centerline of the detector, the “blinds” could be tilted upward to further reduce the detector's view of the background radiation from the ground, while not adversely impacting the detector's view of the target. When talking about background radiation that comes from the ground, gamma radiation is the primary radiation of concern. However, the same technique could be used to improve the signal-to-noise response of a detector for alpha or beta radiation (if the interfering alpha or beta source was coming from one predominant direction).

Other shielding materials that would be operative include tungsten and gold (or any other material that has high atomic number, high density, and is not radioactive itself).

It will also be understood by persons skilled in the art that the present invention, as described hereinabove, can optionally be operated remotely, with a network having one or more or a plurality of detection array panels, or as a stand alone system.

The detector array 10 preferably is readily integrated into a panel of a portal monitoring system. It will be understood by those skilled in the art that the present invention will further require a power source (not shown) and a form of indicator device (not shown) for displaying a positive/negative detection of radiation.

In addition to the above, it is contemplated that the array operation can be controlled from a remote location. For example, the system can include means for wireless transmission of data from the system, such as a panel individually or simultaneously from several panels arranged as a unit. One example of such means can include a network monitoring solution which allows monitoring of the faults and performances of devices, hardware components, applications, databases, services and networks. A network can also provide a web-based control panel accessible to administrators and managers for monitoring using the Internet infrastructure any device connected to the net irrespective of its location. Conventional components used in such web based applications such as routers, switches, monitors, etc. can be employed and are well known in the art.

What is claimed is:

1. An array of radiation detectors comprising:
at least one detector capable of detecting both low and high energy gamma radiation and adapted to provide spectrometric identification of the gamma source;
at least one detector capable of detecting and providing spectrometric identification of fast neutrons and low resolution gamma spectra;
at least one detector adapted to detect thermal neutrons; and,
at least one plastic scintillator to give enhanced gamma ray sensitivity.

2. The array of claim 1, wherein the detector of i) is selected from at least one low energy photon detector sensitive to low energy gamma radiation for suppressing competing background from high energy radiation or included with at least one Nal (Tl) detector.

3. The array of claim 1, further including additional high resolution detectors selected to enhance radioactive isotope identification.

4. The array of claim 1, wherein said array is incorporated in a panel, said panel having processing means.

5. The array of claim 1, further including means for wireless data transmission.

6. The array of claim 1, further including means for data fusion techniques.

7. The array of claim 1, wherein i) comprises sodium iodide activated by thallium (Nal(Tl)) detectors.

8. The array of claim 2, wherein said low energy photon detector comprises Nal (Tl) (activated by thallium) scintillator backed by Csl (Na) scintillator.

9. The array of claim 1, wherein iii) comprises liquid scintillation fast neutron detectors with a volume of the order of 5 inch diameter×24 inch long.

10. The array of claim 1, wherein the spatial arrangement of i) to iv) is designed to distribute sensitivity uniformly over the detecting surface.

11. The array of claim 1, wherein said array is adapted to be controlled from a remote location.

12. The array of claim 4, wherein each panel includes processing means for calibrating and correcting raw data from each of (i) to (iv) to yield an output.

13. The array of claim 4, wherein the panel comprises part of a system having a plurality of panels.

14. The array of claim 13, wherein said plurality of panels are configured to form a portal monitor for one of pedestrians, parcels, vehicles, containers or rail cargo.

15. The array of claim 14, further including a power source and an indicator device.

16. The array of claim 15, wherein said portal monitor unit is remotely controlled.

17. A portal monitor for detecting radiation from a target, comprising:
at least one panel, each said panel including an array having:
at least one detector capable of detecting both low and high energy gamma radiation;
at least one liquid scintillator-based detector capable of neutron/gamma pulse-shape discrimination to provide spectrometric identification of fast neutrons and low resolution gamma spectra;
at least one detector for thermal neutrons,
at least one plastic scintillator to give enhanced gamma ray sensitivity; and,
a shielding baffle mounted on each said panel for reducing background radiation interference emanating from at least below said target.

18. The portal monitor of claim 1 7, wherein said shielding baffle is of a Venetian-blind configuration.

19. The portal monitor of claim 18, wherein said background radiation being shielded is low energy gamma, alpha or beta.

20. A method for real-time radiation detection, comprising:
providing a detector array having a face and including (i) at least one detector capable of detecting both low and high energy gamma radiation, (ii) at least one liquid scintillator-based detector capable of neutron/gamma pulse-shape discrimination to provide spectrometric identification of fast neutrons and low resolution gamma spectra, (iii) at least one detector for thermal neutrons, and (iv) at least one plastic scintillator to give enhanced gamma ray sensitivity, with said face directed at a target;
positioning at least one baffle substantially horizontally against said face of said detector array, said face having a lowest edge and said at least one baffle being at said lowest edge for said baffle to protrude outwardly and transversely across the width said face;
shielding each of (i) to (iv) with said at least one baffle to produce a raw data;
processing said raw data at each detector of said detector array to calibrate and correct said raw data; and,
yielding an output from said processed data sufficient for the desired identification.
